(19) United States
(12) Patent Application Publication
(10) Pub. No.: US 2006/0182377 A1
(43) Pub. Date: Aug. 17, 2006

(54) Rolling bearing

(75) Inventor: Yoshinobu Akamatsu, Mie-ken (JP)

Correspondence Address: ARENT FOX PLLC, 1050 CONNECTICUT AVENUE, N.W., SUITE 400, WASHINGTON, DC, 20036, US

(73) Assignee: NTN CORPORATION

(21) Appl. No.: 11/321,468

(22) Filed: Dec. 30, 2005

(30) Foreign Application Priority Data
Feb. 17, 2005 (JP) 2005-040971

(51) Int. Cl. F16C 33/62

(52) U.S. Cl. 384/492

(57) ABSTRACT

Rolling bearing is disclosed in which the surfaces of the rolling elements or raceway surfaces is randomly formed with an innumerable number of independent minute recessed depressions 11, the regions other than the depressions being smooth surfaces, and when an equivalent circle diameter of not more than φ3 μm excluded, the average area of the depressions is from not less than 10 μm² to not more than 70 μm², the maximum area being 1200 μm².

### BACKGROUND OF THE INVENTION

1. Field of the Invention

This invention relates to a rolling bearing.

2. Brief Description of the Prior Art

Surface damage to rolling bearings is generally relevant to a film thickness parameter (Λ=h/σ) expressed in the ratio of the film thickness h in the rolling contact section to the compound roughness σ. That is, when the oil film parameter Λ decreases, direct contact occurs between the rolling elements of a rolling bearing, causing surface damage, thereby shortening the life of the rolling bearing. When the oil film parameter Λ increases, this results in long life.

Therefore, conventionally, in order to reduce surface damage to rolling bearings so as to prolong the life, factors including the viscosity of lubricants have been selected according to usage conditions so that direct contact between the rolling elements may not occur in the region of contact between the rolling elements and raceway rings of the rolling bearing. Further, when the oil film thickness formed by a lubricant is small, direct contact between the rolling elements has been prevented by reducing the roughness of the finished surface of the rolling bearing.

In this connection, even if the oil film parameter Λ under usage conditions for the rolling bearing is large, the thickness of the oil film formed between the rolling elements becomes smaller when the amount of supply of lubricant is small. This state of shortage of lubricant is generally called starvation.

The thickness of the oil film formed in the contact section between the rolling elements can be calculated from the theory of elastohydrodynamic lubrication. The oil film thickness in this case is a value under the condition that a sufficient amount of lubricant is present in the inlet to the contact section. The oil film thickness under sufficient lubricant conditions is expressed by h∞.

On the other hand, recent researches have shown that when sufficient lubricant is not fed to the inlet to the contact section (under starvation conditions), the thickness of the oil film in the contact section decreases. The oil film thickness h in this case is given by the product of the oil film thickness h∞ under sufficient lubrication conditions and the coefficient β(h=βh∞, β≦1). This coefficient β, as shown in FIG. 5, is 1 when the position (Xi in the figure) of the lubricant present in the inlet to the contact region is large as compared with the contact half width (b); the coefficient approaches zero as the position becomes smaller. Although the results of researches obtained up to now fail to provide correct prediction of the position Xi for the presence of lubricant where β takes 1, generally it is believed that not less than three times of the contact half width (b) is sufficient for lubrication.

Starvation occurs from poor performance of a supply device for lubricant. Besides, in recent years, starvation has occurred because usage conditions for rolling bearings include higher speeds.

At present, the finished surfaces of the rolling elements of a rolling bearing have their roughness reduced by super finishing, to the extent that they can be the to be almost mirror surfaces. Therefore, it is difficult to solve the problem of starvation by reducing the compound roughness in the oil film parameter Λ.

Further, if the viscosity of the lubricant is increased in order to increase the oil film thickness in the oil film parameter Λ, this causes a problem of energy loss since the increase of viscosity increases frictional loss. Further, in the case of lowering the usage temperature in order to increase the oil film thickness, this requires a cooling device or the like.

The minute surface shape composed of randomly formed, independent minute recessed depressions and smooth surfaces other than depressions is superior in oil film forming capability as compared with the depression-less smooth surfaces and provides a long life, as is known in the art (Japanese Patent Application Laid-Open under No. H02-168021). Under starvation conditions with less supply of lubricant, however, if the amount of lubricant trapped in the recesses becomes larger with respect to the amount of supply, there is a possibility that the effect of the increase of oil film thickness by the presence of the depressions cannot be expected.

### SUMMARY OF THE INVENTION

An object of the invention is to provide a rolling bearing which is capable of reducing oil film breakage between the rolling elements even when used under starvation conditions.

The invention provides a rolling bearing having a pair of bearing parts contacted with each other through a lubricant (e.g., lubricating oil), the two bearing parts being relatively movable in a fixed direction, wherein the surface of the contact section of at least one of the pair of bearing parts is randomly formed with independent minute recessed depressions, the regions other than the depressions being smooth surfaces, the size and depth of the depressions being determined.

That is, a rolling bearing according to the invention is characterized in that the surfaces of the rolling elements or at least one of the raceway surfaces of the raceway rings is randomly formed with an innumerable number of independent minute recessed depressions, the regions other than the depressions being smooth surfaces, and in that when an equivalent circle diameter of not more than φ3 μm is excluded, the average area of the depressions is from not less than 10 μm² to not more than 70 μm², the maximum area being 1200 μm².

The volume of the depressions may range from not less than 0.007 mm³/cm² to not more than 0.017 mm³/cm².

According to this invention, the metal contact ratio in the rolling contact section is low even under starvation conditions. Therefore, the oil film forming capability of the rolling bearing with a small amount of oil supply can be improved, and the rolling bearing life can be prolonged.

### BRIEF DESCRIPTION OF THE DRAWINGS

FIG. 1A is a sectional view of a general rolling bearing (cylindrical roller bearing), and FIG. 1B is a front view of a rolling element (cylindrical roller) showing an embodiment of the invention;

FIG. 2 is a diagrammatic view for explaining a comparative testing method about oil film forming capability;

FIGS. 3A and 3B are views for explaining a method of calculating the volume of surface roughness depressions;

FIG. 4 is a graph showing the comparative test results about oil film forming capability; and

FIG. 5 is a diagrammatic view for explaining the relation between the amount of oil supply and the oil film thickness.

### DESCRIPTION OF THE PREFERRED EMBODIMENT

An embodiment of the invention will now be described with reference to the accompanying drawings.

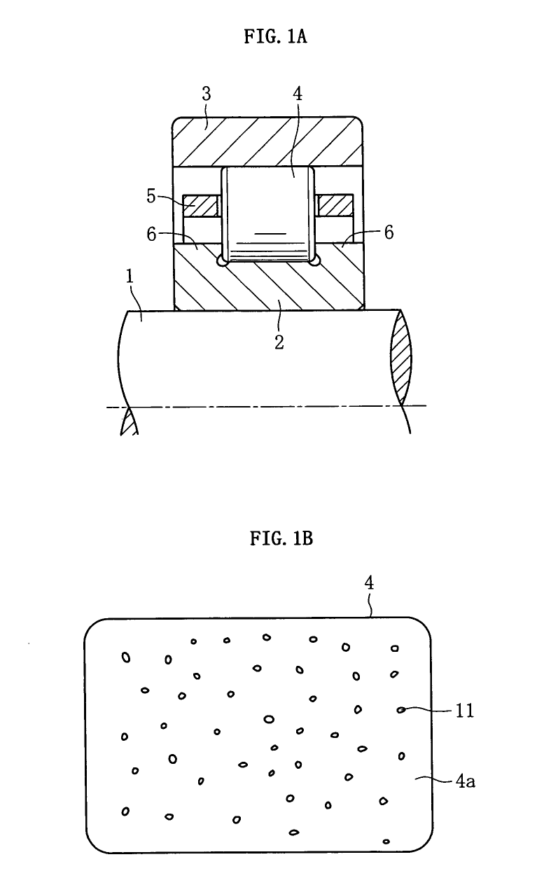

FIG. 1A is a sectional view of a cylindrical roller bearing shown as typical of general rolling bearings. As illustrated, this bearing is composed of various bearing parts including an inner raceway ring (hereinafter referred to as the “inner ring”) 2 fitted on a shaft 1, an outer raceway ring (hereinafter referred to as the “outer ring”) 3 fitted in the inner diameter surface of a housing (not shown), a plurality of cylindrical rollers (hereinafter referred to simply as “rollers”) 4 interposed between the inner and outer rings 2 and 3, and a cage 5 for holding the rollers 4 at circumferentially equispaced positions. The opposite ends of the inner ring 2 are integrally formed with flanges 6 which support axial loads and which contact-wise guide the opposite ends of the rollers 4.

The surfaces of the rolling elements of the rolling bearing or at least one of the raceway surfaces of the inner and outer rings is randomly formed with an innumerable number of independent minute recessed depressions, the regions other than the depressions being smooth surfaces. What is shown by way of example in FIG. 1B is a case where the surface (the rolling surface) 4a of a roller 4 has minute recessed depressions 11 randomly dispersed. When an equivalent circle diameter of not more than φ3 μm is excluded, the average area of the depressions is from not less than 10 μm² to not more than 70 μm², the maximum area being 1200 μm². To show the average area, maximum area, and volume by way of example, inventive examples are as shown in Table 1.

Next, experiments conducted to demonstrate the effects of the invention will be described.

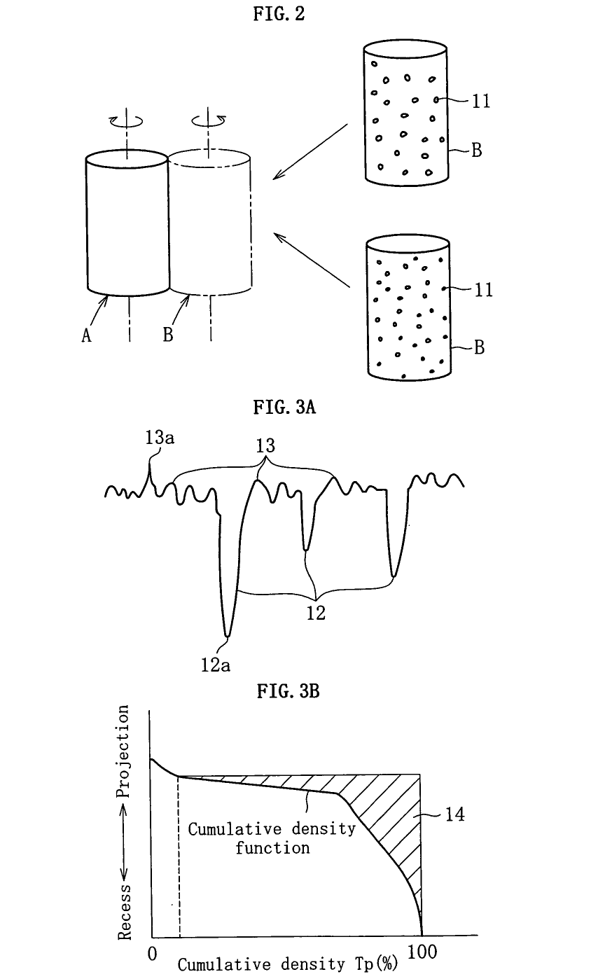

In the experiments, as shown in FIG. 2, two test cylinders A and B made of bearing steel were contacted and the contact electric resistance between the two cylinders was measured. In the case where the two cylinders are separated by a lubrication film, the resistance becomes infinite since lubricating oil is an insulator, and in the case where metal contact occurs between the two cylinders, the resistance becomes zero. The two cylinders had a diameter of φ40 mm, a hardness of HV750, and a rotative speed of 1900 rpm. The lubricating oil used was Turbine Oil ISO-VG32, and the maximum contact pressure between the two cylinders was 1.4 GPa.

In order to supply a small amount of lubricating oil to the contact section between the two cylinders, a specified amount was applied to the outer diameter surfaces of the two cylinders before test, and oiling was not performed during test. The management of the amount of application was made by measuring the amount of lubricating oil before and after application by a balance. Further, application of a very small amount of lubricating oil was performed by a method comprising the steps of diluting turbine oil with a solvent and applying it to the test cylinders. In that case, subsequent to the application, after the solvent had evaporated from the outer diameter surfaces of the test cylinders, the weights of the test cylinders were measured by the balance to calculate the amount of application.

Of the two test cylinders, one which had been super-finished was used as the test cylinder A in any test. A cylinder in which the depressions 11 were varied in size and dispersed was used as the test cylinder B. The characteristics of the depressions in the test cylinder B with which tests were conducted are shown in Table 1.

TABLE 1

| | Characteristics of depressions | | | |
|---|---|---|---|---|
| | Area | | | |
| Test | percentage | Average | Maximum | Volume |
| cylinder | (%) | area (μm²) | area (μm²) | (mm³/cm²) |
| Comparative | 16 | 141 | 3000 | 0.033 |
| example 1 | | | | |
| Comparative | 11 | 104 | 1430 | 0.022 |
| example 2 | | | | |
| Inventive | 8 | 70 | 1120 | 0.017 |
| example 1 | | | | |
| Inventive | 21 | 30 | 500 | 0.010 |
| example 2 | | | | |
| Inventive | 14 | 10 | 300 | 0.007 |
| example 3 | | | | |

The area percentage, average area, and maximum area of the depressions were measured by using Image Processor PIAS LA-525. The microscope used was Microscope BH made by Olympus Optical Co., Ltd, the magnification power of the objective lens being 10. The enlarged image formed by the microscope was inputted into an image processor through a CCD monochrome video camera. The size of the visual field which was the object of image processing was 832 μm×730 μm. With the image processor, the brightness of the monochrome video image was digitized with 256 gradations, and a threshold value was set so as to binalizingly discriminate the depressions into a black (brightness zero) smooth section and a white (brightness 255) section. In image binalization, in order to eliminate the effects of minute scratches and dirt formed on the surface f the test cylinder on measurements, an object having an equivalent circle diameter of not more than φ3 μm and a brightness of zero was subjected to the noise eraser process to have a brightness of 255.

Subsequent to the process, the area percentage, average area, and maximum area of the depressions were measured. The volume of the depressions was measured by using Roughness Meter Talysurf S5C. In addition, with this measuring instrument, the volume of the depressions is indicated as a parameter Vo. The measurements were performed by using a diamond probe 90-degree which was a standard probe for roughness meters. The measurement length was 4 mm and the cut-off was 0.25 mm. As for the filter, a Gauss filter was used. An example in which a surface composed of depressions and a smooth surface is measured by a roughness meter is shown in FIG. 3A. the individual depressions become troughs 12, while projections of small irregularities in the smooth section become peaks 13. Here, the distance between the deepest trough 13a and the highest peak is the maximum roughness of the surface shape.

FIG. 3B shows the cumulative density function for the surface roughness in FIG. 3A. The cumulative density function for surface roughness is sometimes called a bearing curve. In this bearing curve, the vertical axis indicates roughness size, and the existence probability over a range from the highest projection 13a to the deepest recess 12a of roughness is shown. The volume Vo of the depressions is the integrated value of the hatched area 14 of the bearing curve. There are various ways of giving Tp % in the case of finding the integrated value; in this case, however, the value of Mr2 was used as Tp %. Mr 2 is defined by taking a width of 40% in the direction of Tp % on the bearing curve in FIG. 3 (B), drawing a line whose gradient is minimum, finding the point of intersection of the line with Tp %=100%, and taking the value of Tp % corresponding to the point of intersection between the horizontal from the point of intersection and the bearing curve, the value of Tp % defining Mr 2. The method of calculating the integrated value of the hatched area (14) of the cumulative density function in FIG. 3 (B) by using Mr 2 is the method specified by DIN4776-1990. The reason why a Gauss filter was used as the filter rather than using an ISO filter is because the measuring conditions were matched with DIN4776-1990.

The minute depressions in the test cylinder B were formed by barreling. The size and depth of the depressions were adjusted by changing the processing time or processing pressure. In addition, besides barreling, the formation of minute recess shape may be effected by using shot peening or rolling.

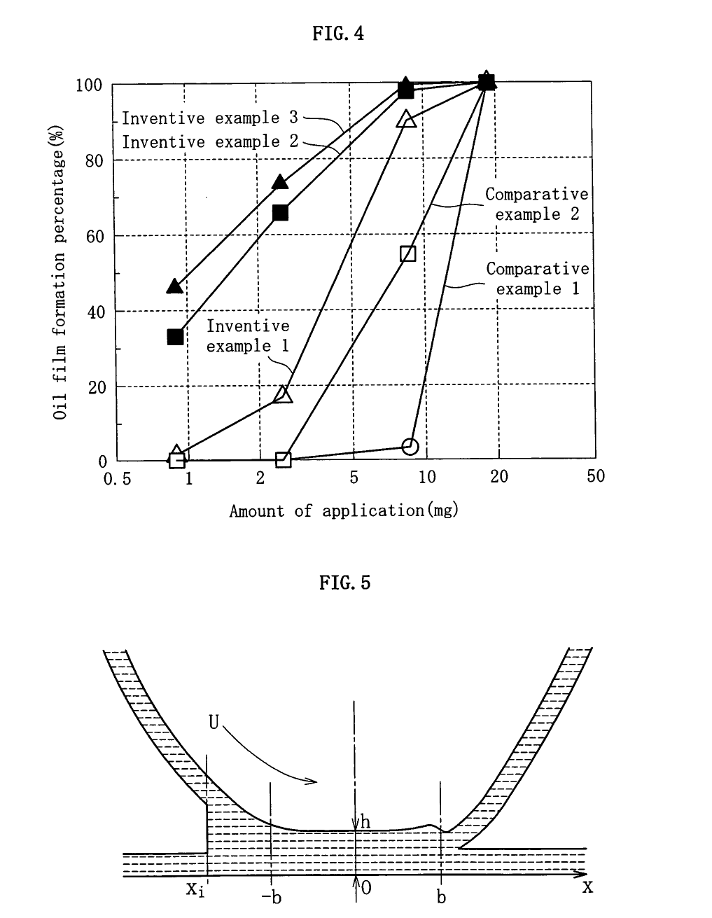

FIG. 4 shows the results of comparison of oil film forming capabilities in the inventive example 1, inventive example 2, inventive example 3, comparative example 1 and comparative example 2 by changing the amount of application. Here, the term “oil film formation percentage” means the oil film formation time ratio which can be calculated from the following formula.

Oil film formation percentage=100×T₁/(T₁+T₂), where T₁ is the time required for the formation of oil films, T₂ is the time at which metal contact occurs, in the measurements using the electric resistance method. It is seen from FIG. 4 that as compared with the comparative examples 1 and 2, the inventive examples 1, 2, and 3 have superior oil film forming capabilities even when the amount of oil supply is small. This improvement in oil film forming capability is believed to be due to the fact that the amount of lubricating oil stored in the depressions, as shown in FIG. 5, is reduced by reducing the size and depth of the depressions, thereby preventing the decrease of the amount of lubricating oil supplied to the inlet to the contact region, allowing the oil film forming capabilities originally possessed by the depressions to be fully developed.

In addition, it goes without saying that under the conditions that the amount of supply of lubricating oil is sufficient and that the oil film thickness is small, the comparative examples 1 and 2 are superior in oil film forming capability as compared with the case of absence of depressions.

What is claimed is:

1. A rolling bearing in which surfaces of the rolling elements or at least one of raceway surfaces of raceway rings is randomly formed with an innumerable number of independent minute recessed depressions, the regions other than the depressions being smooth surfaces, wherein when an equivalent circle diameter of not more than φ3 μm is excluded, the average area of the depressions is from not less than 10 μm² to not more than 70 μm², the maximum area being 1200 μm².

2. A rolling bearing as set forth in claim 1, wherein the volume of the depressions is from not less than 0.007 mm³/cm² to not more than 0.017 mm³/cm².
